(19) United States
(12) Patent Application Publication
(10) Pub. No.: US 2004/0223417 A1
(43) Pub. Date: Nov. 11, 2004

(54) Audio storage and playback device and method of controlling same

(76) Inventors: David John Bardsley, Manchester, MI (US); Jeffery Allan Sparks, Livonia, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/430,602

(22) Filed: May 6, 2003

(51) Int. Cl. G11B 7/085

(52) U.S. Cl. 369/30.09

(57) ABSTRACT

A device for the storage and playback of audio signals originating from at least one portable medium includes a player for reading audio information from a portable medium having a plurality of audio tracks. The player transmits an audio output signal corresponding to a selected audio track. A storage device operatively connects to the player for receiving the output signal and storing the plurality of audio tracks. The device further includes a user interface control panel. A controller is adapted to receive user input from the control panel regarding desired playback of a selected track and records the playback information of the selected track in memory to prioritize the tracks relative to one another. The controller is further adapted to receive user input to control the player and the storage device to play at least portions of the stored plurality of audio tracks such that playing of the tracks is dependant on the playback information.

### BACKGROUND OF THE INVENTION

This invention relates in general to sound systems, and in particular to a vehicular audio storage and playback device.

Sound systems, and in particular vehicle mounted sound systems, typically include a player for reading audio information stored on prerecorded portable audio medium. Examples of common audio media include compact discs and magnetic tapes or discs. Commonly, the audio information stored on the audio medium includes multiple songs which are divided into separate tracks. The audio information stored on the prerecorded audio medium can be in digital or analog format. When the player is actuated to play a particular track, the player reads the audio information in that track and produces an audio output signal corresponding to the audio information. If the signal is digital, the signal is received by a modulator which converts the signal to an analog output signal suitable for distribution to one or more speakers mounted in the vehicle. An amplifier is connected between the modulator and the speaker to provide sufficient power for the signal to power the speakers.

The player is connected to a control panel having a plurality of controls mounted thereon which are actuated by the operator or user of the system. The user can actuate the controls to play all of the tracks in sequential order. Alternatively, the user may advance the playing order and select a desired track to listen to. Since the player plays the tracks in sequential order, the player continues to play the remainder of the tracks starting with the track immediately after the selected track. A common scenario for users of sound systems, especially in vehicles in which the controls are readily accessible, is that the user is constantly shifting the order of track selection either because the user does not wish to listen to all of the tracks in the preprogrammed order, or more commonly because the user does not wish to listen to every track but rather a select few. Another common scenario is that the user is frequently changing discs (or other suitable audio medium) once the user has listened to a selected few favorite tracks prerecorded on a particular disc.

It is therefore desirable to provide an audio system, in particular for a vehicle mounted audio system, in which the user's preferences for the particular playing of tracks on a particular audio medium are known so that the user may remain focused on the driving aspects of the vehicle instead of frequently adjusting the controls of the sound system.

### BRIEF SUMMARY OF THE INVENTION

This invention relates to an audio storage and playback device, in particular for a vehicle, which preferably has mass audio data storage capability and is capable of playing back selected tracks in accordance to user preferences learned by the device.

A device for the storage and playback of audio signals originating from at least one portable medium includes a player for reading audio information from a portable medium having a plurality of audio tracks. The player transmits an audio output signal corresponding to a selected audio track. A storage device operatively connects to the player for receiving the output signal and storing the plurality of audio tracks. The device further includes a user interface control panel. A controller is adapted to receive user input from the control panel regarding desired playback of a selected track and records the playback information of the selected track in memory to prioritize the tracks relative to one another. The controller is further adapted to receive user input to control the player and the storage device to play at least portions of the stored plurality of audio tracks such that playing of the tracks is dependent on the playback information.

The present invention also relates to a method of storing and playing of audio signals. The method includes first providing a player for reading audio information from a portable medium having a plurality of audio tracks. The plurality of audio tracks are then stored in a storage device. User input is received from an interface control panel regarding desired playback of selected tracks from the plurality of audio tracks. Playback information of the selected track is recorded to prioritize the tracks relative to one another. User inputs are then received from the control panel to play at least portions of the stored plurality of audio tracks. The selected tracks of the plurality of audio tracks are then played, wherein selection of the tracks is dependent on the playback information.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a schematic block diagram view of a sound system in accordance with the present invention.

FIG. 2 is a schematic diagram of a user interface control panel for controlling the sound system.

### DETAILED DESCRIPTION OF THE INVENTION

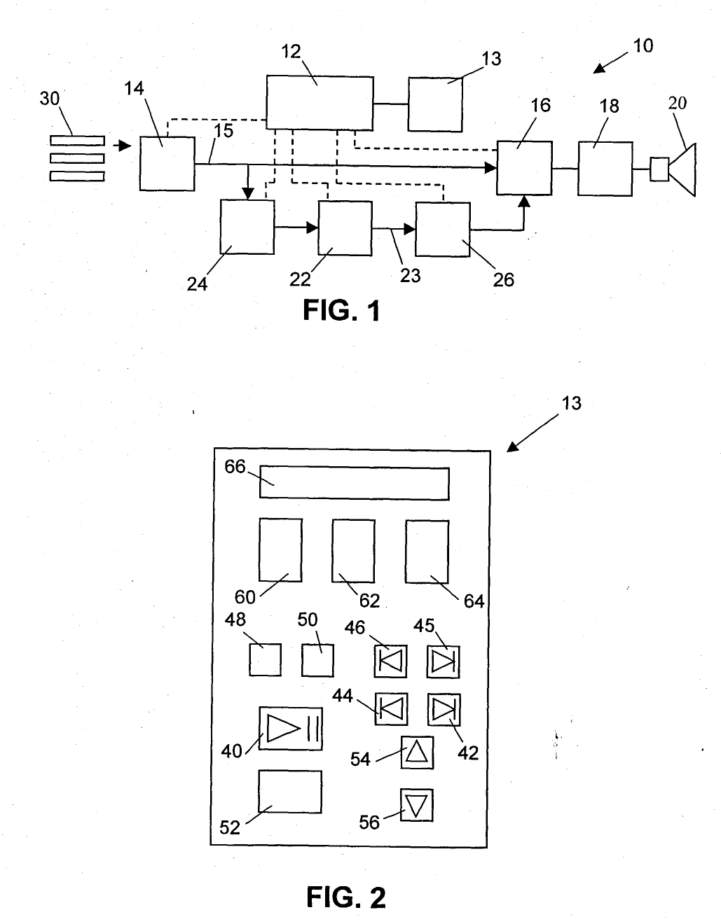

Referring now to the drawings, there is illustrated in FIG. 1 a sound system, indicated generally at 10, in accordance with the present invention. Preferably, the sound system is adapted to be installed and used in a vehicle. Although the system 10 is well suited for being used and mounted within a vehicle, it should be understood that the system could be used outside of a vehicle environment. The system 10 generally includes a controller 12, a user interface control panel 13, a player 14, a modulator 16, an amplifier 18, at least one speaker 20, and a mass storage device 22. The system 10 preferably also includes a data compressor 24 and a data decompressor 26. As will be discussed in detail below, the controller 12 is preferably connected to the components of the system, such as the player 14, the modulator 16, the mass storage device 22, the data compressor 24, and the data decompressor 26 for controlling the components per the commands of the user via the user interface control panel 13.

The various components of the system 10 can be integrated together and share various electrical hardware or can be separately mounted and housed from the other components. The system 10 plays sound or audio files from a plurality of prerecorded audio media. Examples of suitable audio media include compact discs 30, digital audio/video discs, magnetic cassette tapes, magnetic discs, and memory chips. Although the system 10 will be described as playing and storing audio information from prerecorded compact discs 30, it should be understood that any suitable audio medium format or medium combinations for distributing large quantities of audio information may be used with the system 10. Thus, the term “compact disc (CD)” as used herein is used for clarity and convenience purposes. It should also be understood that the audio medium may be recorded from an auxiliary audio source such as a separate player connected to an input jack connected to the system 10 or, alternatively, from a radio tuner incorporated into the system 10. The audio information on the medium can be stored and retrieved with any suitable digital or analog encoding format.

As will be discussed in detail below, the system 10 of the present invention has mass data storage capability for storing audio information from the compact discs 30 and is capable of playing back selected tracks in accordance to user preferences learned by the system 10.

The player 14 can be a conventional audio player, such as a compact disc player, which is capable of reading audio information from a compact disc. The CD player 14 generally includes a drive motor which spins the disc 30. A reader, such as a laser and lens system, focuses a beam on the disc to read a plurality of bumps or depressions on a spiral track formed on the disc 30. The bumps and depressions of the spiral track correspond to a digital format of the audio information. A tracking mechanism moves the laser so that the beam can follow the spiral track. After reading the audio information, the player 14 transmits an audio output signal 15 corresponding to the audio information read from the disc 14. As is standard with most players, the player 14 plays all of the audio tracks of the disc 30 in sequential order. However, the player 15 can be controlled such that the user may advance the playing order and select a desired track to listen to. Since the player 14 plays the tracks in sequential order, the player 14 continues to play the remainder of the tracks starting with the track immediately after the selected track.

The player 14 can be a single CD player or a multi-CD player. A single CD player is typically mounted on the instrument panel and is within easy access to the driver of the vehicle. The single CD player accepts one CD 30 at a time and is controllable to play any track on that CD 30. A multi CD player accepts one or more CDs 30 within a transport mechanism and is capable of selecting a desired one of the CDs loaded therein for playing any track thereon. Some multi CD players use a cartridge which is preloaded by the user with a desired number of CDs 30. The transport mechanism of the CD player selects the desired CD from the cartridge and loads the CD into a reader assembly. Often, these multi CD players using cartridges are located remotely from the driver or user. Other multi CD players have the appearance of a single CD player in that a single slot is used to load one CD at a time, but the CD player includes a transport mechanism for stacking and storing a plurality of CDs therein for independent retrieval when a desired CD is selected for playing by the user. The multi CD players allow the user to control the playing of multiple CDs without having to remove and reload single CDs at a time.

The modulator 16 is connected to the player 14 and the storage device 22. The modulator 16 includes electronic circuitry which converts the audio output signal 15 received from the CD player (or storage device 22 as will be discussed below) into an analog signal 17 corresponding to the audio information read from the compact disc 30. The amplifier 18 is connected between the modulator 16 and the speaker 20 to amplify the analog signal 17 to provide sufficient power for the signal to power the speaker 20, thereby playing the selected track as read by the player 14.

The mass storage device 22 is operatively connected to the player 14 for selectively receiving the audio output signal 15 from the player 14 and storing the audio information therefrom for subsequent retrieval. After retrieval of the desired audio information, the storage device transmits an audio output signal 23, similar to the audio output signal 15, to the modulator 16 for playback. Thus, the audio information from a CD 30 can be stored onto the storage device and be later recalled by the user. The storage device 22 can be any suitable device which is capable of storing a relatively large amount of information, either in a digital or analog format corresponding to the audio output signal 15 from the player 14. A suitable device for the storage device 22 is a hard disk or hard drive, similar to those used in the computer industry. A hard drive uses a rigid metal disk coated with a magnetic material on which data can be stored and retrieved by a read/write head. Memory devices suitable for storing the digital data may also be used for the storage device 22. The memory device may include magnetic or optical devices, removable flash memory, or solid-state floppy disk cards.

The system 10 may also include a switching device (not shown) located at the output of the player 14. The switching device may be controllable by the controller 12 to distribute the audio output signal 15 to either the modulator 16 for playback or to the storage device 22 for recordation. Preferably, the switching device or function thereof is incorporated into the controller 12.

To minimize storage space within the storage device, the system 10 can optionally include the data compressor 24 to compress the data retrieved from the compact disc 30s into a more size-efficient form. The optional data decompressor 26 decompresses the audio data and formats the audio output signal 23 for proper configuration for the modulator 16. For example, the audio or data information contained on a compact disc is generally in a CDDA format. Although this data format provides relatively high quality audio sound performance, the amount of data required to replicate audio music is relatively large. The playback environment of the vehicle, in particular, may not need the high sound quality level produced by the CDDA format and therefore, a less data intensive format may be more suitable. Suitable known data formats include MP3, Midi, and WAV as are commonly known in the industry. Of course, it should be understood that the storage device 22 can store the audio data or information in any suitable format which can be subsequently retrieved and transmitted to the modulator 16 for proper playback.

The user interface control panel 13, an embodiment of which is illustrated in FIG. 2, includes a plurality of controls, knobs or buttons which receive user input to control the system 10 as desired by the user. It should be understood that the control panel 13 as illustrated in FIG. 2 is only one suitable control panel arrangement and that the system 10 may include other controls and features not described herein. Preferably, the control panel 13 includes a play/pause button 40, a track search forward button, 42, a track search reverse button 44, a disc skip forward button 45, a disc skip reverse button 46, a store button 48, a delete button 50, a shuffle button 52, a priority increase button 54, a priority decrease button 56, the reasons for which will be explained below. The control panel 13 also preferably includes various displays including a disc number display 60, a track number display 62, a priority number display 64, and an information display 66.

The system 10 can be operated to play tracks from the player 14 or the storage device 22 in a variety of ways. For example, the system 10 can be operated to play a selected track from a CD received in the player 14. For a single CD player, the user can select the play/pause button 40 to start playing of the CD. For multi CD players, the user can select a particular disc from a plurality of CDs loaded into the player by using the disc skip forward button 45 and the disc skip reverse button 45 to select the appropriate disc. Preferably, the player 14 designates each particular CD loaded therein with a corresponding number displayed in the disc number display 60. For example, the first disc loaded into the player can have be designated with a number “1”, and a second disc loaded into the player can be designated with a number “2”, etc.

During playing of the CD, the user can also skip the currently playing track to another track by selecting the appropriate track search forward button 42 and track reverse search button 44. The currently playing track number is displayed in the track number display 62. The control panel 13 may also include the information display 66 for displaying auxiliary information related to the currently playing CD or track, such as the artist or song title. The auxiliary information can be obtained from data embedded into the CD itself or can be programmed by the user.

The player 14 could be designed to read the CD at multiples of the standard playing speed of the CD such that the recording process time period is shortened. The player 14 could also be configured such that the track or entire CD being recorded onto the storage device 22 is also simultaneously played through the speakers 20 of the system 10. If the player 14 is reading the audio information on the CD at a higher rate, the audio information may be stored in an auxiliary buffer memory which transmits the audio information at normal playing speed to the modulator 16 for proper playback.

The system 10 is also capable of storing audio tracks into the storage device 22 from CDs inserted into the CD player. The user can store all of the tracks of a particular CD, or the user can alternatively store only selected tracks, thereby conserving storage space in the storage device 22. To store audio tracks into the storage device 22, the user selects the store button 48 during playing of the CD. The store button 48 (or multiple store buttons) could be configured to store only the currently playing track or all of the tracks of the CD. Preferably, the user would be able to selectively chose the type of track recording. Preferably, each CD which is recorded and stored in the storage device 22 is designated with a designation number in a similar manner as described above with respect to the disc number display 60. Thus, the user can select the information from the recorded CD in a similar manner as a CD which is loaded into the player 14. For example, for a single CD player, the designation number “0” could correspond to the CD loaded into the player 14 and the designation numbers “1”, “2”, etc. may refer to CDs which have been previously stored in the storage device 22. Thus, the user simply selects the appropriate designated number via the disc skip buttons 45 and 46 to access the stored tracks of the previously recorded CD. As additional CDs are recorded, the number designation is increased to the next available designation number. The tracks of the stored CD can be accessed in a similar manner with the track search buttons 42 and 44, as described above.

It should also be understood that the storage device can receive audio information from other sources other than the player 14. For example, a separate player my be connected to the system via an input jack (not shown) which connects to the modulator 16 and/or mass storage device 22. The separate player may then download the audio information in a similar manner as the player 14 as described above. Alternatively, a radio tuner may be incorporated into the system 10 which connects to the modulator 16 and/or storage device 22.

Preferably, the system 10 is also configured such that previously stored CDs or selected tracks of a particular CD can be deleted from the storage device, thereby increasing the storage capacity of the storage device. To delete an entire CD or desired track(s), the user would recall the desired CD by selecting the corresponding designation number via the disc skip buttons 45 and 46 and then select the delete button 50. The delete button 50 (or multiple delete buttons) could be configured to delete only the currently playing track or all of the tracks of the CD.

Preferably, the system 10 is capable of playing back selected tracks, either from a loaded CD in the player 14 or a stored track in the storage device 22, in accordance to user preferences learned by the system 10. Essentially, the system 10 learns which tracks are most liked by the user and plays those tracks when the user selectively enters into a preferential playback mode, thereby simulating a user defined favorite list of tracks. Also, the system 10 learns which tracks are less liked by the user and may infrequently play these tracks compared to the likable tracks. To accomplish this user preferential playback mode, the controller records playback information related to each track to prioritize a particular track relative to other tracks stored in the storage device. Thus, each track is preferably designated with a priority designation number comparing its ranking with other tracks. Although the preferential playback mode will be discussed with respect to accessing the tracks stored in the storage device it should be understood that tracks in the loaded CD in the player 14 or a separate player may also be accessed.

It should also be understood that the user may wish to play a loaded CD or one of the stored CDs in a conventional manner such that all of the tracks are played in a sequential order. Alternatively, the user can place the system 10 into the preferential playback mode. The preferential playback mode can play preferred tracks in a variety of combinations, for example, from only the loaded CD, a single stored CD stored in the storage device 22, all of the stored CDs in the storage device 22, or any combination thereof. Also, the playback mode can play preferred tracks from The system 10 could also be entered into a shuffle mode, via the shuffle button 52 to randomize the sequence of the playback. The shuffle mode can likewise by designated for the loaded CD, a single stored CD stored in the storage device 22, all of the stored CDs in the storage device 22, or any combination thereof.

Preferably, the priority designation number is ranked such that the higher the number, the greater the user would wish to hear that particular track over tracks having a lower priority designation number. For example, the designation “0” could be assigned to tracks in which the user wishes not to hear that track when in the preferential playback mode. A designation number of “1” could be used as the default number for all new tracks. The tracks having a designation number higher than “1”, would then get preferential playing over the default “1” designations.

An example of a playing ranking will now be described. The preferentially playback mode can be entered into by selecting the shuffle button 52 or any other command button (shown or not shown). Thus, user input from the control panel controls the playing of at least portions of the stored plurality of audio tracks. When entered into a preferential playback mode, the controller 12 may first play the tracks having the highest ranking number first. Subsequently, the tracks designated with the next highest number would then played, and so on. The user may also configure the preferential playback mode such that only tracks having a similar designation number are played. Alternatively, the user may configure the preferential playback mode such that tracks having a selected designation number of higher are played. The system may also be configured such that tracks having a high designation number are played more frequently than lower designation numbers.

To obtain a track ranking via a priority designation number, the number can be created or adjusted by either direct input from the user or by playback information relating to that track such as number of times the track has been played or the length of the playing time of the track, as will be explained below. To adjust the priority designation number, the user can view the track's designation number via the priority number display 64, and then select either the priority increase button 54 or the priority decrease button 56. Thus, the system 10 can be modified as the user's preferences change.

The controller 12 itself may also adjust the priority designation number by receiving various playback information relating to that particular track. The playback information received from the controller to assign the designation number can be based on various criteria. An example of suitable playback information includes the number of times the track is played and/or selected by the user. Another suitable playback information criteria includes the length of time the track has been played. Thus, although a particular track may be played often, the user may skip the track soon after the tracks starts playing by selecting the track skip buttons 42 and 44. Thus, if only the number of times a track was played was used to determine the priority ranking, a “false” designation number may be assigned. Any suitable combinations of number of times a track is played and the length of time the track is played may be used to determine a priority designation number. Another example of suitable playback information includes the elapsed time since the track has been played. The preferential playback mode could be configured such that recently played tracks are given a higher priority designation number. Alternatively, the user may enter into a preferential playback mode in which recently played tracks are given a lower priority designation number.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A device for the storage and playback of audio signals originating from at least one portable medium having a plurality of tracks of audio information, said device comprising:
a player for reading audio information from a portable medium having a plurality of audio tracks, and transmitting an audio output signal corresponding to a selected audio track;
a storage device operatively connected to said player for receiving said output signal and storing the plurality of audio tracks;
a user interface control panel; and
a controller connected to said control panel, said controller adapted to receive user input from said control panel regarding desired playback of a selected track and recording the playback information of the selected track in memory to prioritize the tracks relative to one another, said controller further adapted to receiving user input from said control panel to control said player and said storage device to play at least portions of the stored plurality of audio tracks such that playing the tracks of the plurality of audio tracks is dependant on the playback information.

2. The device of claim 1, wherein the playback information received by said controller includes the length of time the track was played.

3. The device of claim 1, wherein the playback information received by said controller includes the number of times the selected track was played.

4. The device of claim 1, wherein said device is adapted to be mounted in a vehicle.

5. The device of claim 1 further including a modulator operatively connected to said player, said modulator adapted to convert said audio output signal to an analog audio signal for distribution to a speaker for playing of said audio signal;

6. The device of claim 1, wherein the portable medium is a compact disc.

7. the device of claim 1, wherein the audio output signal is in an analog format.

8. The device of claim 1, wherein the audio output signal is in a digital format.

9. The device of claim 1, wherein said storage device is a hard drive.

10. The device of claim 1, wherein said storage device further includes a data compressor, wherein said audio output signal is compressed to decrease the data information of the stored signal in the storage device.

11. A method of storing and playing of audio signals comprising:
a. providing a player for reading audio information from a portable medium having a plurality of audio tracks;
b. storing the plurality of audio tracks in a storage device;
c. receiving user input from an interface control panel regarding desired playback of selected tracks from the plurality of audio tracks;
d. recording playback information of the selected track to prioritize the tracks relative to one another;
e. subsequently to step (c), receiving user input from the control panel to play at least portions of the stored plurality of audio tracks; and
f. playing selected tracks of the plurality of audio tracks, wherein selection of the tracks is dependent on the playback information.

12. The method of claim 11, wherein the storage device stores a plurality of audio tracks from a plurality of difference portable mediums.

13. The method of claim 11, wherein the playback information includes the number of times the track has been played.

14. the method of claim 13, wherein the selection is dependant on the playback information such that selected ones of the plurality of audio tracks are given higher priority than other ones of the plurality of audio tracks based on the number of times the track is played.

15. The method of claim 11, wherein the playback information includes the length of time the track has been played.

16. The method of claim 15, wherein the selection is dependant on the playback information such that selected ones of the plurality of audio tracks are given higher priority than other ones of the plurality of audio tracks based on the length of time of the track was played.

17. The method of claim 11, wherein the playback information includes the elapsed time since the track has been played.

18. The method of claim 11, wherein subsequent to step (f), playback information is recorded of the selected track for additionally prioritizing the tracks relative to one another.

19. The method of claim 11, wherein the user can actuate the control panel to alter the prioritization of the track currently playing.

20. A device for storing and playing of audio signals in accordance with the method of claim 11.
